(19) United States
(12) Patent Application Publication
(10) Pub. No.: US 2004/0117487 A1
(43) Pub. Date: Jun. 17, 2004

(54) Apparatus and method for capturing an event or combination of events resulting in a trigger signal in a target processor

(76) Inventor: Gary L. Swoboda, Sugar Land, TX (US)

Correspondence Address: TEXAS INSTRUMENTS INCORPORATED, P O BOX 655474, M/S 3999, DALLAS, TX, 75265

(21) Appl. No.: 10/729,564

(22) Filed: Dec. 5, 2003

Related U.S. Application Data
(60) Provisional application No. 60/434,121, filed on Dec. 17, 2002.

(51) Int. Cl. G06F 15/16

(52) U.S. Cl. 709/228

(57) ABSTRACT

In a target processor, trigger signals that result in changes in the program execution must be identified and communicated to a host processing unit. The trigger signals are generated in response to preselected event signals. The event signals are generated by event signal generation units responsive to specified target processor conditions. Upon generation of a trigger signal, the event signals resulting in the generation of the trigger signal are stored in related locations in a storage unit. The contents of the storage unit can be transferred to the host processing unit for analysis. A related program counter address can also be transferred to the host processing unit.

This application claims priority under 35 USC §119(e)(1) of Provisional Application No. 60/434,121 (TI-34660P) filed Dec. 17, 2002.

### RELATED APPLICATIONS

U.S. patent application (Attorney Docket No. TI-34654), entitled APPARATUS AND METHOD FOR SYNCHRONIZATION OF TRACE STREAMS FROM MULTIPLE PROCESSORS, invented by Gary L. Swoboda, filed on even date herewith, and assigned to the assignee of the present application; U.S. patent application (Attorney Docket No. TI-34655), entitled APPARATUS AND METHOD FOR SEPARATING DETECTION AND ASSERTION OF A TRIGGER EVENT, invented by Gary L. Swoboda, filed on even date herewith, and assigned to the assignee of the present application; U.S. patent application (Attorney Docket No. TI-34656), entitled APPARATUS AND METHOD FOR STATE SELECTABLE TRACE STREAM GENERATION, invented by Gary L. Swoboda, filed on even date herewith, and assigned to the assignee of the present application; U.S. patent application (Attorney Docket No. TI-34657), entitled APPARATUS AND METHOD FOR SELECTING PROGRAM HALTS IN AN UNPROTECTED PIPELINE AT NON-INTERRUPTIBLE POINTS IN CODE EXECUTION, invented by Gary L. Swoboda and Krishna Allam, filed on even date herewith, and assigned to the assignee of the present application; U.S. patent application (Attorney Docket No. TI-34658), entitled APPARATUS AND METHOD FOR REPORTING PROGRAM HALTS IN AN UNPROTECTED PIPELINE AT NON-INTERRUPTIBLE POINTS IN CODE EXECUTION, invented by Gary L. Swoboda, filed on even date herewith, and assigned to the assignee of the present application; U.S. patent application (Attorney Docket No. TI-34659), entitled APPARATUS AND METHOD FOR A FLUSH PROCEDURE IN AN INTERRUPTED TRACE STREAM, invented by Gary L. Swoboda, filed on even date herewith, and assigned to the assignee of the present application; U.S. patent application (Attorney Docket No. TI-34661), entitled APPARATUS AND METHOD FOR CAPTURING THE PROGRAM COUNTER ADDRESS ASSOCIATED WITH A TRIGGER SIGNAL IN A TARGET PROCESSOR, invented by Gary L. Swoboda, filed on even date herewith, and assigned to the assignee of the present application; U.S. patent application (Attorney Docket No. TI-34662), entitled APPARATUS AND METHOD DETECTING ADDRESS CHARACTERISTICS FOR USE WITH A TRIGGER GENERATION UNIT IN A TARGET PROCESSOR, invented by Gary Swoboda and Jason L. Peck, filed on even date herewith, and assigned to the assignee of the present application; U.S. patent application (Attorney Docket No. TI-34663), entitled APPARATUS AND METHOD FOR TRACE STREAM IDENTIFICATION OF A PROCESSOR RESET, invented by Gary L. Swoboda, Bryan Thome and Manisha Agarwala, filed on even date herewith, and assigned to the assignee of the present application; U.S. patent (Attorney Docket No. TI-34664), entitled APPARATUS AND METHOD FOR TRACE STREAM IDENTIFICATION OF A PROCESSOR DEBUG HALT SIGNAL, invented by Gary L. Swoboda, Bryan Thome, Lewis Nardini and Manisha Agarwala, filed on even date herewith, and assigned to the assignee of the present application; U.S. patent application (Attorney Docket No. TI-34665), entitled APPARATUS AND METHOD FOR TRACE STREAM IDENTIFICATION OF A PIPELINE FLATTENER PRIMARY CODE FLUSH FOLLOWING INITIATION OF AN INTERRUPT SERVICE ROUTINE; invented by Gary L. Swoboda, Bryan Thome and Manisha Agarwala, filed on even date herewith, and assigned to the assignee of the present application; U.S. patent application (Attorney Docket No. TI-34666), entitled APPARATUS AND METHOD FOR TRACE STREAM IDENTIFICATION OF A PIPELINE FLATTENER SECONDARY CODE FLUSH FOLLOWING A RETURN TO PRIMARY CODE EXECUTION, invented by Gary L. Swoboda, Bryan Thome and Manisha Agarwala filed on even date herewith, and assigned to the assignee of the present application; U.S. patent application (Docket No. TI-34667), entitled APPARATUS AND METHOD IDENTIFICATION OF A PRIMARY CODE START SYNC POINT FOLLOWING A RETURN TO PRIMARY CODE EXECUTION, invented by Gary L. Swoboda, Bryan Thome and Manisha Agarwala, filed on even date herewith, and assigned to the assignee of the present application; U.S. patent application (Attorney Docket No. TI-34668), entitled APPARATUS AND METHOD FOR IDENTIFICATION OF A NEW SECONDARY CODE START POINT FOLLOWING A RETURN FROM A SECONDARY CODE EXECUTION, invented by Gary L. Swoboda, Bryan Thome and Manisha Agarwala, filed on even date herewith, and assigned to the assignee of the present application; U.S. patent application (Attorney Docket No. TI-34669), entitled APPARATUS AND METHOD FOR TRACE STREAM IDENTIFICATION OF A PAUSE POINT IN A CODE EXECTION SEQUENCE, invented by Gary L. Swoboda, Bryan Thome and Manisha Agarwala, filed on even date herewith, and assigned to the assignee of the present application; U.S. patent application (Attorney Docket No. TI-34670), entitled APPARATUS AND METHOD FOR COMPRESSION OF A TIMING TRACE STREAM, invented by Gary L. Swoboda and Bryan Thome, filed on even date herewith, and assigned to the assignee of the present application; U.S. patent application (Attorney Docket No. TI-34671), entitled APPARATUS AND METHOD FOR TRACE STREAM IDENTIFCATION OF MULTIPLE TARGET PROCESSOR EVENTS, invented by Gary L. Swoboda and Bryan Thome, filed on even date herewith, and assigned to the assignee of the present application; and U.S. patent application (Attorney Docket No. TI-34672 entitled APPARATUS AND METHOD FOR OP CODE EXTENSION IN PACKET GROUPS TRANSMITTED IN TRACE STREAMS, invented by Gary L. Swoboda and Bryan Thome, filed on even date herewith, and assigned to the assignee of the present application are related applications.

### BACKGROUND OF THE INVENTION

1. Field of the Invention

This invention relates generally to the testing of digital signal processing units and, more particularly, to the detection of events in a target processor that result in the generation of a trigger signal. The trigger signal events must be related to the program execution and transferred to a host processing unit for test and debug purposes.

2. Description of the Related Art

As microprocessors and digital signal processors have become increasingly complex, advanced techniques have been developed to test these devices. Dedicated apparatus is available to implement the advanced techniques. Referring to FIG. 1, a general configuration for the test and debug of a target processor is shown. The test and debug procedures operate under control of a host processing unit 10. The host processing unit 10 applies control signals to the emulation unit 11 and received (test) data signals from the emulation unit 11 by cable connector 14. The emulation unit 11 applies control signals to and receives (test) signals from the target processing unit 12 by connector cable 15. The emulation unit 11 can be thought of as an interface unit between the host processing unit 10 and the target processor 12. The emulation unit 11 must process the control signals from the host processor unit 10 and apply these signals to the target processor 12 in such a manner that the target processor will respond with the appropriate test signals. The test signals from the target processor 12 can be a variety of types. Two of the most popular test signal types are the JTAG (Joint Test Action Group) signals and trace signals. The JTAG signal provides a standardized test procedure in wide use. Trace signals are signals from a multiplicity of junctions in the target processor 12. While the width of the bus interfacing to the host processing unit 10 generally have a standardized width, the bus between the emulation unit 11 and the target processor 12 can be increased to accommodate the increasing complexity of the target processing unit 12. Thus, part of the interface function between the host processing unit 10 and the target processor 12 is to store the test signals until the signals can be transmitted to the host processing unit 10.

Referring to FIG. 1B, the operation of the trigger generation unit 19 is shown. At least one event signal is applied to the trigger generation unit 19. Based on the event signals applied to the trigger generation unit 19, a trigger signal is selected. Certain events and combination of events, referred to as an event front, generate a selected trigger signal that results in certain activity in the target processor such as a debug halt. Combinations of different events generating trigger signals are referred to as jobs. Multiple jobs can have the same trigger signal or combination of trigger signals. In the test and debug of the target processor, the trigger signals can provide impetus for changing state in the target processor or for performing a specified activity. The event front defines the reason for the generation of trigger signal.

In the test and debug of the target processor, part of the test apparatus monitors conditions within the target processor. Typically, monitored conditions are selected by the user. As a result of the monitoring, when the selected condition is identified, an event signal is generated. This signal or a combination of event signals are applied to a trigger unit. When the appropriate event signal or combination of event signals are applied to the trigger unit, a change in the operation of the target processor results. For example, the trigger unit may initiate a interrupt, a debug halt, or some other activity. The reason for the change in the operation of the target processor is frequently necessary to perform the test and debug analysis.

A need has been felt for apparatus and an associated method having the feature that the events resulting in the generation of a trigger signal can be identified. It would be yet another feature of the apparatus and associated method to provide for the identification of the target processor events leading to the generation of a trigger signal. It would be yet another feature of apparatus and associated method to identify the instruction in the code that resulted in the generation of the trigger event. It would be a still further feature of the present invention to transfer the identity of the instruction generating the trigger signal to the host processing unit for analysis.

### SUMMARY OF THE INVENTION

The aforementioned and other features are accomplished, according to the present invention, by providing a capture register having at least one position coupled to each possible event signal. When an event signal (or signals) is generated, the event signal is applied to a trigger generation unit and to the associated position(s) in the capture register. When the event signal(s) generate a trigger signal, the trigger generation unit also applies a control signal to the capture register. The capture register can then store an indicia of the event signal(s) in an associated location (or locations) and apply the signals stored in the capture register to a read bus, the transmitted signals identifying the event(s) resulting in the trigger signal. The contents of the capture register can then be transferred to the host processing unit for analysis by JTAG or other methods. Similarly, the contents of the program counter that resulted in the generation of trigger signal are stored in a second register after a delay resulting for the delay in the execution of the related instruction. The contents of program counter are stored in the second register after a delay resulting from the execution of the instruction and in response to a control signal from the trigger unit.

Other features and advantages of present invention will be more clearly understood upon reading of the following description and the accompanying drawings and the claims.

### BRIEF DESCRIPTION OF THE DRAWINGS

FIG. 1A is a general block diagram of a system configuration for test and debug of a target processor, while FIG. 1B illustrates the function of the trigger unit.

FIG. 2, a block diagram of the apparatus for storing the event signals that result in the generation of a trigger signal.

FIG. 3 is a block diagram of apparatus for storing the contents of the program counter related to the generation of the trigger signal according to the present invention.

### DESCRIPTION OF THE PREFERRED EMBODIMENT

1. Detailed Description of the Figures

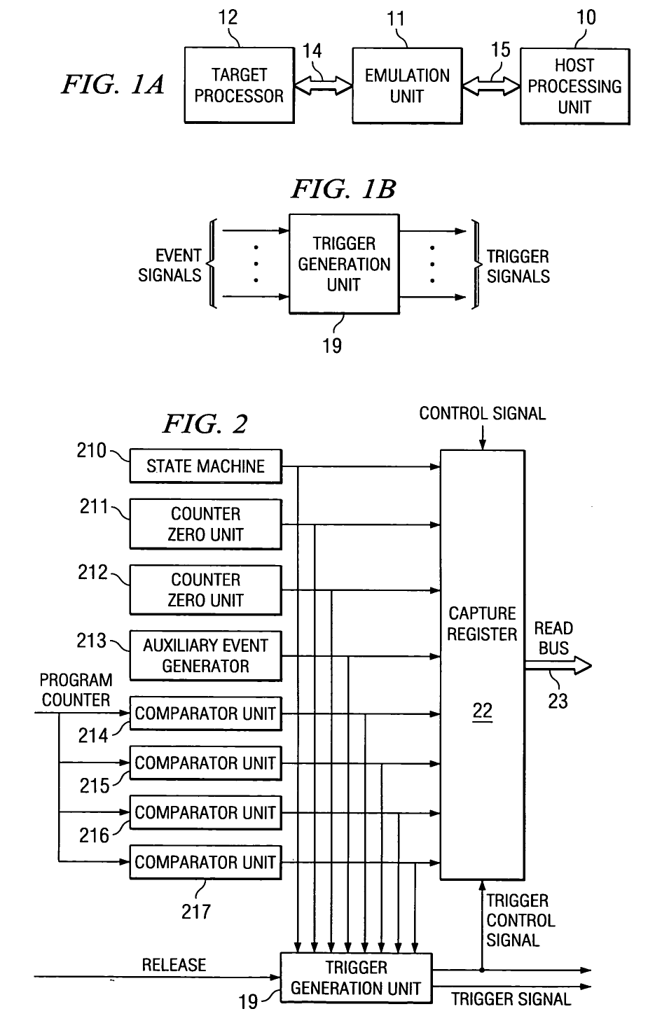

FIG. 1 has been described with respect to the related art.

Referring to FIG. 2, a block diagram of the apparatus for capturing the identification of the events resulting in a trigger signal is shown. A plurality of target processing unit and test and debug components can provide an event signal under preselected conditions. The components generating event signals include a state machine 210 (determining the state in which the target processing unit is executing code), counter zeros unit 211 and 212 (determining when a preselected condition has been met), an auxiliary event generating unit 213 (providing an event signal for a predetermined condition of the target processor), and comparators 214-217 (for identifying program counter generated events). Each of the components providing event signals are coupled to a particular input terminal of trigger generating unit 19 and to an associated location in the capture register 22. When an event signal or preselected combination of event signals is identified by the trigger generation unit 19, an appropriate trigger signal is generated. Along with the trigger signal, the trigger generation unit 19 generates a control signal. The control signal results in the storage of the applied event signals in the capture register 22. The contents of the capture register 22 can be applied to a read bus 23 and subsequently transferred to the host processing unit for analysis.

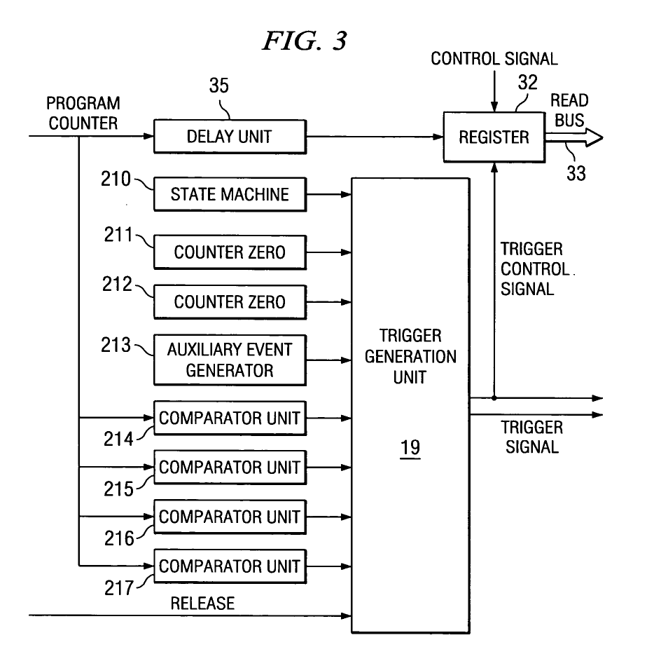

Referring to FIG. 3, a block diagram of the apparatus for storing the contents of the program counter related to the generation of a trigger signal is shown. As in FIG. 2, the state machine 210, the counter zero units 211 and 212, the auxiliary event generator 213, and the comparators, 214-217, in the presence of preselected conditions, generate event signals that are applied to the trigger generation unit 19. In response to a preselected event signal or combination of event signals, the trigger generation unit 19 generates a trigger signal. The trigger signal causes a predetermined response by the target processor. In addition, the trigger generation unit 19 provides a control signal. This control signal is applied to register 32. The contents of program counter are applied through a delay line 35 to the register 32. In response to the trigger control signal, the program counter contents are stored in the register 32. In response to a control signal, the contents of register 32 can be transferred to the host processing unit.

2. Operation of the Preferred Embodiment

In analyzing the operation of target processing system, it is important to know the events that result in the change in operation. The present invention captures an identification of the events that result in the change in operation, e.g., the transition to and interrupt service routine. These events are captured only in the event that an actual trigger signal is generated. Upon the generation of a trigger signal, signals specifying the events causing the trigger signal are stored and can be transferred the host processing unit for analysis. In addition, it is necessary to determine where in the program execution the trigger signal occurred as well as the events that resulted in the generation of the trigger signal. The contents of the program counter are the best indication of the state of program execution at the time of the trigger signal. However, because of the pipeline delay (and, if present, a pipeline flattener delay), the events that result in the generation of the trigger signal are the result of instructions that began execution before the delay. Consequently, in order to correlate the events causing the trigger signal with the appropriate instruction identified by the program counter, the delay is added in the instruction applied to the register. In this manner, the target processor events resulting in the generation of a trigger signal and the related position in the instruction execution can be identified transferred to the host processing unit for analysis.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. In a target processor, apparatus for storing a events related to the generation of a trigger signal, the apparatus comprising:
a plurality of event signal generation units, each event signal generation unit providing an event signal in response to a preestablished target processor condition
a trigger generation unit coupled to the plurality of event signal generation units, the trigger generation unit responsive to at least one preselected event signal for generating an associated trigger signal, the trigger generating unit generating a trigger control signal; and
a register, the register having the event signals applied to the trigger unit applied thereto, the register responsive to a trigger control signal generated along with the trigger signal, the trigger control signal causing the register to store event signals applied thereto.

2. The apparatus as recited in claim 1 further comprising at least one event signal generating unit, each event signal generating unit generating an event signal upon identification of a predetermined condition in the target processor.

3. The apparatus as recited in claim 1 further comprising a read bus, wherein a second control signal causes the contents of the register to be applied to the read bus.

4. The apparatus as recited in claim 3 wherein the register is a memory-mapped register.

5. The apparatus as recited in claim 1 further comprising:
a second register, the second register responsive to the control signal for storing a program counter address related to the conditions in the target processor resulting in the events signals.

6. The method of storing an events signals resulting in the generation of a trigger signal, the method comprising:
generating an event signal for each predetermined event;
applying each event signal to a trigger generation unit;
applying each event signal to a preselected storage unit location;
when a predetermined event signal or predetermined combination of event signals is applied to the trigger generation unit, the trigger generation unit providing a trigger signal and a trigger control signal; and
applying the trigger control signal to the storage unit, the storage unit storing the event signals in the storage unit in response to the trigger control signal.

7. The method as recited in claim 6 wherein the storage unit is a register.

8. The method as recited in claim 6 wherein applying a control signal to the storage unit results in application of the contents of the storage unit to a read bus.

9. The method as recited in claim 6 further comprising the step storing program counter address in a second storage unit in response to the trigger control signal.

10. A target processor comprising:
at least one event detection unit, each event detection unit responsive to predetermined condition of the target processing unit for generating a related event signal;
a trigger generation unit, the trigger generation unit generating trigger signal in response to at least one of the related event signals, the trigger unit generating a trigger control signal when the a trigger signal is generated; and
a storage unit, the storage unit coupled to the event detection unit, the storage unit storing each event signal is a related storage unit location in response to the trigger control signal.

11. The target processor as recited in claim 10 further comprising a read bus coupled to the storage unit, the event signals stored in the storage unit being applied to the read bus in response to a second control signal.

12. The target processor as recited in claim 11 wherein the storage unit is a memory-mapped register accessible to an external test and debug device.

13. The target processor as recited in claim 10 further comprising a second storage unit, the second storage unit having a program counter address applied thereto, the storage unit storing applied program counter address in response to the trigger control signal.

14. The target processor as recited in claim 13 further comprising a delay line, the delay line delaying the application of the program counter address to the second storage unit for a predetermined period of time.

15. The target processor as recited in claim 14 wherein the second storage unit is a memory-mapped register.
